(19) United States
(12) Patent Application Publication
(10) Pub. No.: US 2021/0233759 A1
(43) Pub. Date: Jul. 29, 2021

(54) ION GUIDE FOR MASS SPECTROMETER AND ION SOURCE USING SAME

(71) Applicant: BIONEER CORPORATION, Daejeon (KR)

(72) Inventors: Taeman KIM, Mungyeong-si (KR); Han-Oh PARK, Sejong-si (KR)

(73) Assignee: BIONEER CORPORATION, Daejeon (KR)

(21) Appl. No.: 15/734,848

(22) PCT Filed: Jun. 4, 2019
(86) PCT No.: PCT/KR2019/006710

§ 371 Date: Dec. 3, 2020

(30) Foreign Application Priority Data
Jun. 4, 2018 (KR) 10-2018-0064056

(51) Int. Cl. H01J 49/06; H01J 49/24; H01J 49/16

(52) U.S. Cl. CPC H01J 49/063; H01J 49/161; H01J 49/24; H01J 49/065

(57) ABSTRACT

An ion guide for transferring ions to a mass analyzer is disclosed. The ion guide is characterized in that a plurality of DC rings and a plurality of RF multi-pole rings with a plurality of electrodes are arranged alternatingly along a central axis between an inlet into which the ions move and an outlet for transferring the ions. The inner diameter of the DC rings is kept constant and the inner diameter of the RF multi-pole rings gradually decreases in a direction from the inlet to the outlet.

### TECHNICAL FIELD

The present invention relates to relates to a mass spectrometer, and more particularly, to an ion guide for a mass spectrometer and an ion source using the same.

### BACKGROUND ART

Various methods have been known as a method of ionizing a target compound component in a sample using mass spectrometry. The ionization can be roughly divided into a method of ionizing in a vacuum atmosphere and a method of ionizing in an approximately atmospheric pressure atmosphere, and the approximately atmospheric pressure atmosphere may be collectively referred to as atmosphere pressure ionization or ambient ionization.

In a mass spectrometer using the atmospheric pressure ionization, a means for effectively transferring ions from an ion source into a high vacuum chamber with the mass spectrometer is required. To this end, a vacuum system including several vacuum stages in which the pressure gradually decreases is used.

However, in order to efficiently transfer ions from each vacuum stage to the next stage, an ion guide with high transfer efficiency is required. In particular, when moving into a first vacuum chamber, ions move according to a flow of air, and the air is freely expanded in a first vacuum stage, and the ions are also scattered in various directions. In order to collect the ions scattered in various directions and pass the ions through an ion lens in the next vacuum stage, an ion guide that effectively collects the ions is required. In particular, in a pressure range of 1 torr, which is a pressure of a first-stage vacuum chamber, a special type of RF ion guide that operates even in a weak electric field is required because an electrical discharge occurs at a lower voltage than in vacuum or an atmospheric pressure.

In this regard, Korean Patent Laid-Open Publication No. 2014-0020152 discloses an RF/DC ion guide for a mass spectrometer in which a plurality of DC rings and a plurality of RF multi-pole rings with a plurality of electrodes are arranged so as to intersect with each other.

FIG. 1 is a view illustrating the existing ion guide, and illustrates an ion guide 100′ having a form in which inner diameters of both a DC ring 110′ and an RF multi-pole ring 120′ gradually decrease. However, the ion guide having such a form has a disadvantage that an electric field generated from the RF multi-pole ring 120′ is formed only around the RF multi-pole ring 120′.

The present inventor has completed the present invention after a long research effort to develop an ion guide capable of compensating for the above-described disadvantages and more effectively transferring ions.

### RELATED ART DOCUMENT

### Patent Document

KR 2014-0020152 A

### DISCLOSURE

### Technical Problem

An object of the present invention is to provide an ion guide capable of further improving ion transfer efficiency by more effectively collecting ions on a central axis of the ion guide compared to the existing ion guide.

Another object of the present invention is to provide an ion source capable of further increasing ionization efficiency by using an ion guide.

### Technical Solution

In one general aspect, there is provided an ion guide for effectively transferring ions, in which a plurality of DC rings and a plurality of RF multi-pole rings with a plurality of electrodes may be arranged so as to intersect with each other between an inlet into which the ions move and an outlet for transferring the ions, and an inner diameter of the DC rings may be kept constant and an inner diameter of the RF multi-pole rings may gradually decrease in a direction from the inlet to the outlet.

In addition, each center of the plurality of DC rings and the plurality of RF multi-pole rings may be located on a straight line.

In addition, the inner diameter of the RF multi-pole ring may decrease at a constant rate.

In addition, the plurality of electrodes of the RF multi-pole ring may be arranged to be spaced apart from each other to form a ring.

Further, the plurality of RF multi-pole rings may have the same distance from the inner diameter to an outer diameter.

In addition, an RF voltage having the same amplitude but different phases may be applied to each neighboring electrode of the RF multi-pole ring.

In addition, different DC bias voltages may be applied to the adjacent DC rings and the RF multi-pole rings.

In another aspect of the present invention, there is provided an ion guide for transferring ions, in which a plurality of DC rings and a plurality of RF multi-pole rings with a plurality of electrodes may be arranged so as to intersect with each other between an inlet into which the ions move and an outlet for transferring the ions, all inner diameters of the DC rings and the RF multi-pole rings may gradually decrease in a direction from the inlet to the outlet, and a degree of decreasing the inner diameter of the RF multi-pole rings may be formed to be greater than that of the DC rings.

In still another aspect of the present invention, there is provided an ion guide for transferring ions, in which a plurality of DC rings and a plurality of RF multi-pole rings with a plurality of electrodes may be arranged so as to intersect with each other between an inlet into which ions move and an outlet for transferring the ions, all inner diameters of the DC rings and the RF multi-pole rings may decrease at the same rate from the inlet to a predetermined distance, after the predetermined distance to the outlet, the inner diameter of the DC rings may be kept constant and the inner diameter of the RF multi-pole rings may gradually decrease, or the inner diameters of the DC rings and the RF multi-pole rings may gradually decrease and a degree of decreasing the inner diameter of the RF multi-pole rings may be formed to be greater than that of the DC rings.

In still yet another aspect, an ion source includes an ionization material source for emitting ionized material; an ionization chamber in which a sample is ionized by the ionized material emitted from the ionization material source; and at least one vacuum chamber for transferring ions of the sample ionized by the ionization chamber to a next ion optical system, in which any one of the ion guides may be embedded in a vacuum chamber.

In addition, the ionization chamber may be constituted by DC electrodes to which a different voltage is applied in a direction from an inlet of the ionization chamber to an outlet and insulators between the DC electrodes.

In addition, a pressure inside the ionization chamber may be higher than a pressure inside a first vacuum chamber in which the ion optical system immediately following the ionization chamber is embedded and lower than an atmospheric pressure.

In addition, a central axis of the ionization chamber and a central axis of the ion guide of the first vacuum chamber may be disposed to be inclined at a predetermined angle.

In addition, an angle formed by a central axis of the ionization chamber and a central axis of the ion guide of the first vacuum chamber may be 10° to 170°.

In addition, an ion deflector may be arranged inside the first vacuum chamber on a side opposite to the ion guide, and an outlet of the ionization chamber may be arranged between the ion deflector and the ion guide.

In addition, the ion source may be a photoionization ion source, a chemical ionization ion source, or a proton transfer reaction ion source.

### Advantageous Effects

In order to effectively transfer the ions from the ion source into the high vacuum chamber with the mass spectrometer, an interface using the vacuum system with several vacuum stages in which the pressure gradually decreases is required. According to the means for solving problem of the present invention, it is possible to exert an excellent effect of increasing the ion transfer efficiency of such an interface and improving the detection sensitivity of the mass spectrometer.

In particular, according to the ion guide of the present invention, a strong electric field may be formed to the central axis of the ion guide far from the electrode of the RF multi-pole ring to more effectively collecting the ions on the central axis of the ion guide, so it is possible to exert an excellent effect that may improve the ion transfer efficiency.

### BRIEF DESCRIPTION OF THE DRAWINGS

FIG. 1 is a diagram illustrating the existing ion guide.

FIG. 2 is a perspective view of an ion guide according to an exemplary embodiment of the present invention.

FIG. 3 is an exemplary view illustrating a side cross-section of the ion guide according to the exemplary embodiment of the present invention and a DC ring and an RF multi-pole ring.

FIG. 4 is a diagram illustrating in detail a configuration and a circuit connection of the DC ring and the RF multi-pole ring of the ion guide according to the exemplary embodiment of the present invention.

FIG. 5 is a diagram illustrating an example of a circuit configuration for the ion guide according to the exemplary embodiment of the present invention.

FIG. 6 is a diagram illustrating an electric field formed by the existing ion guide and an electric field formed by the ion guide according to the exemplary embodiment of the present invention.

FIG. 7 is a perspective view and a cross-sectional view of an ion guide according to another exemplary embodiment of the present invention.

In addition, FIG. 8 is a cross-sectional view of an ion guide according to still another exemplary embodiment of the present disclosure.

FIG. 9 is a diagram schematically illustrating a configuration of an ion source according to another exemplary embodiment of the present disclosure.

FIG. 10 is a diagram illustrating in detail an ionization material source and an ionization chamber of FIG. 9.

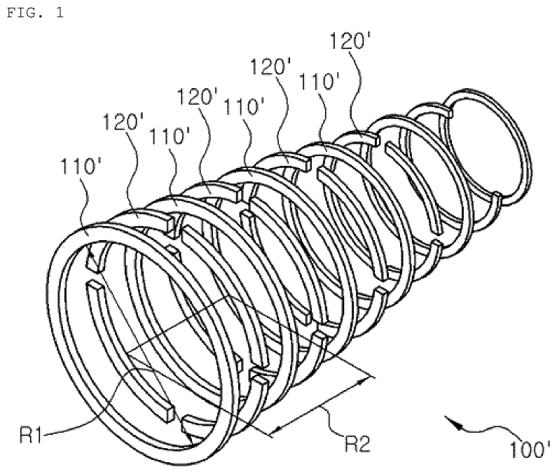

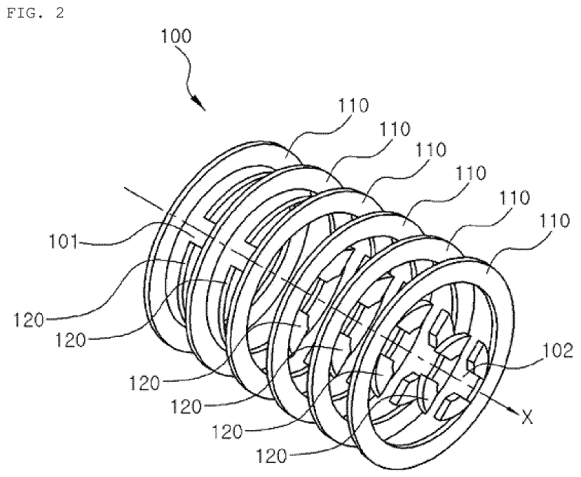

### BEST MODE

In the case of a mass spectrometer (API-MS) that uses atmospheric pressure ionization, how efficiently ions are transferred from an ion source to a vacuum with the mass spectrometer is a major factor in determining analytical performance of equipment.

In other words, ion transfer efficiency becomes an important factor in determining a detection limit of the mass spectrometer. The modern API-MS uses a vacuum system that goes through several vacuum stages in which the pressure gradually decreases, and uses ion guides in each vacuum stage. The present invention effectively collects ions scattered at various angles, and reduces energy of ions by a collision of the ions with a background gas, so the ions are collected on a central axis of the ion guide and are efficiently transferred to the next stage.

The ion guide according to the present invention has a shape in which DC rings and RF multi-pole rings (low thickness ring-shaped multi-pole electrodes) are alternately stacked. In one of the RF multi-pole rings, RF voltages having the same amplitude but a phase difference of 180° from each other are applied to neighboring electrodes to form a multi-pole electric field inside the ring.

At this time, the plurality of DC rings have the same inner diameter, but the plurality of RF multi-pole rings are configured so that the inner diameters of each of the RF multi-pole rings gradually decrease in a direction from an inlet to an outlet, and as a result, the RF multi-pole electric field generated from the neighboring RF multi-pole rings may be maintained even inside the DC ring to some degree and a strong electric field may be formed up to the central axis of the ion guide.

In addition, different DC voltages are applied between the adjacent DC ring and RF multi-pole ring to generate a DC electric field in a direction of the central axis within the ion guide. Due to the effect of the RF electric field between the DC ring and the multi-pole electrodes and the effect of the RF multi-pole electric field in a radial direction, ions are collected close to the central axis of the ion guide, and move in an axial direction of the ion guide by the DC electric field formed in the axial direction of the ion guide and are transferred to an ion optical system following the ion guide.

Hereinafter, exemplary embodiments of the present invention will be described in detail with reference to the accompanying drawings. Further, in describing the present invention, if it is determined that the related known functions are obvious to those skilled in the art and thus may unnecessarily obscure the subject matter of the present invention, the detailed description thereof will be omitted.

FIG. 2 illustrates an ion guide according to an exemplary embodiment of the present invention. As illustrated, an ion guide 100 of the present invention may have a structure in which DC rings 110, 110 . . . and RF multi-pole rings 120, 120 . . . are arranged to be successively intersect with each other along a central axis X, an inner diameter of the DC ring 110 is kept constant in a direction from an inlet 101 to an outlet 102, and an inner diameter of the RF multi-pole ring 120 gradually decreases.

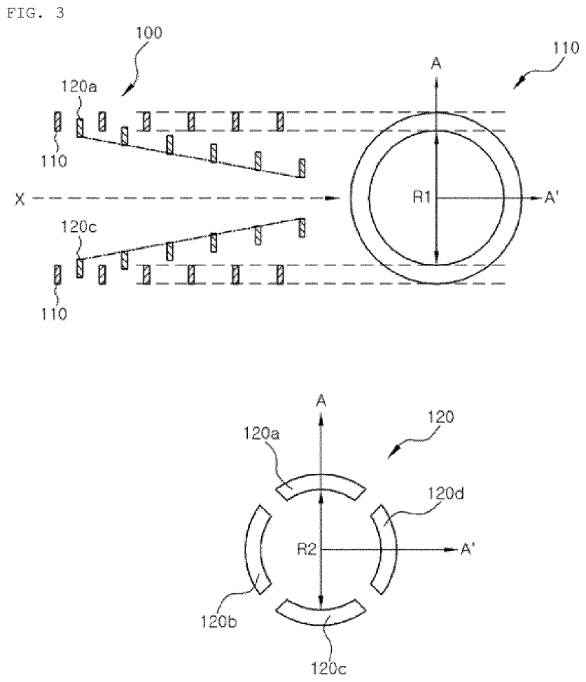

FIG. 3 is a side cross-sectional view of an ion guide according to the present invention and a DC ring and an RF multi-pole ring. The ion guide 100 of the present invention may be configured so that each center of a plurality of DC rings 110 and a plurality of RF multi-pole rings is located on a straight line.

The ion guide 100 of the present invention may be configured so that inner diameters R1 of the plurality of DC rings 110 are the same along the central axis X, and inner diameters R2 of the plurality of RF multi-pole rings 120 gradually decrease along the central axis X.

Here, the ion guide 100 of the present invention may be formed in any form as long as the inner diameters of each of the RF multi-pole rings 120 of the ion guide 100 gradually decrease in a direction from the inlet 101 to the outlet 102, but is preferably configured so that the inner diameters R2 of each of the RF multi-pole rings 120 of the ion guide 100 decrease at a predetermined rate in the direction from the inlet 101 to the outlet 102.

That is, when the RF multi-pole ring 120 is a first RF multi-pole ring, a second RF multi-pole ring, . . . ,an n-th RF multi-pole ring in close order to the inlet 101, the ion guide 100 of the present invention may be configured so that the rate of the inner diameter of the first RF multi-pole ring and the inner diameter of the second RF multi-pole ring is the same as the rate of the inner diameter of the second RF multi-pole ring and the inner diameter of the third RF multi-pole ring, which may be formed to be identically maintained up to the nth RF multi-pole ring.

Further, each of the plurality of RF multi-pole rings 120 may have the same distance from the inner diameter to the outer diameter. That is, the distances from the inner diameter to the outer diameter of the first RF multi-pole ring to the nth RF multi-pole ring described above may all be the same.

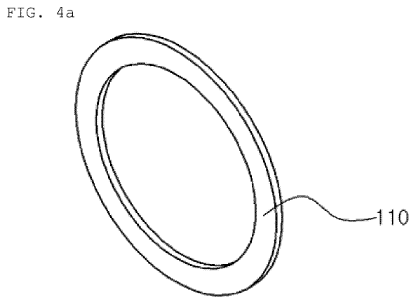

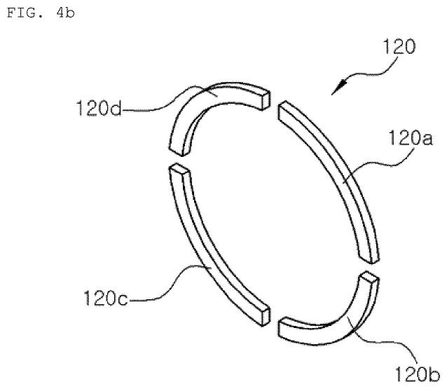

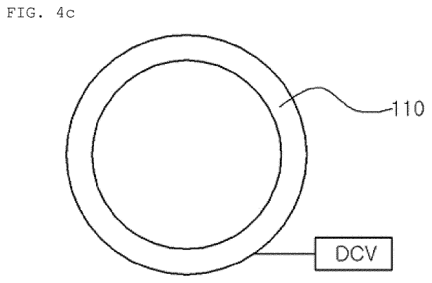

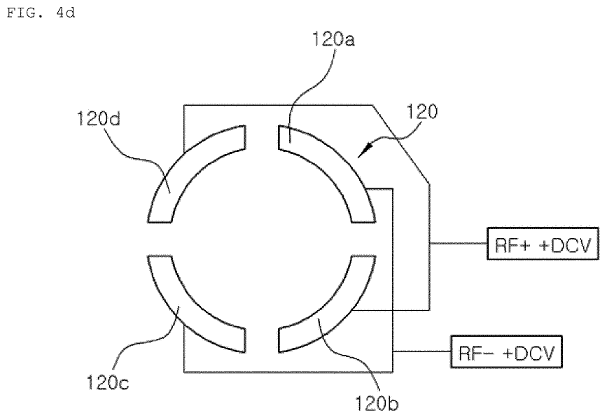

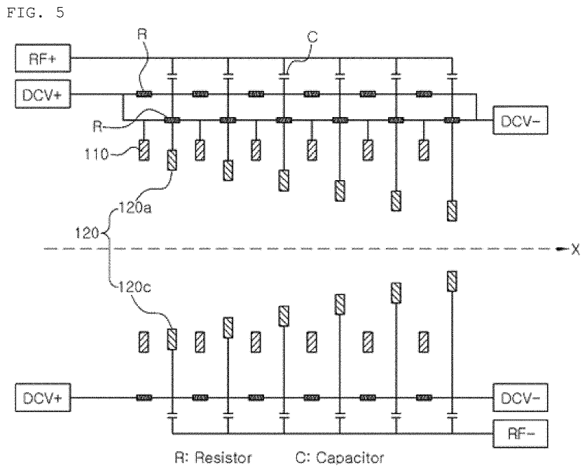

FIG. 4 illustrates the DC ring 110 and the RF multi-pole ring 120 constituting the ion guide 100 in more detail. FIG. 4A illustrates a shape of one DC ring 110, and FIG. 4B illustrates a shape of one RF multi-pole ring 120. As illustrated in FIG. 4B, in the RF multi-pole ring 120, four segmented electrodes 120a, 120b, 120c, and 120d form a ring shape.

In addition, as illustrated in FIG. 4c, a DC voltage is applied to the DC ring 110, and as illustrated in FIG. 4d, voltages having the same amplitude but different phases are applied to adjacent electrodes of each electrode 120a, 120b, 120c, and 120d of the RF multi-pole ring 120, and the same DC voltage is overlappingly applied thereto. That is, RF voltages having the same amplitude but different phases are applied to each neighboring electrode of the RF multi-pole ring 120, so an RF multi-pole electric field is generated inside the ring.

As illustrated in FIG. 5, voltages applied to the ion guide 100 may be applied by a DC voltage dividing electric circuit, an AC capacitor parallel connection, and a DC and RF power supply. The electrodes (for example, 120a and 120c, and 120b and 120d) having the same phase in the neighboring multi-pole electrodes 120a, 120b, 120c, and 120d are arranged in the same radial direction.

Different voltages are applied to each ring by the DC voltage dividing circuit, and the DC electric field is generated in the direction of the central axis X inside the ion guide 100 by the difference in DC voltage of the ring. According to the present invention, different DC bias voltages are applied to the adjacent DC ring 110 and RF multi-pole rings 120 to form a DC electric field in the direction of the central axis X inside the structure of the ring arrangement, so ions may move in the direction of the central axis X.

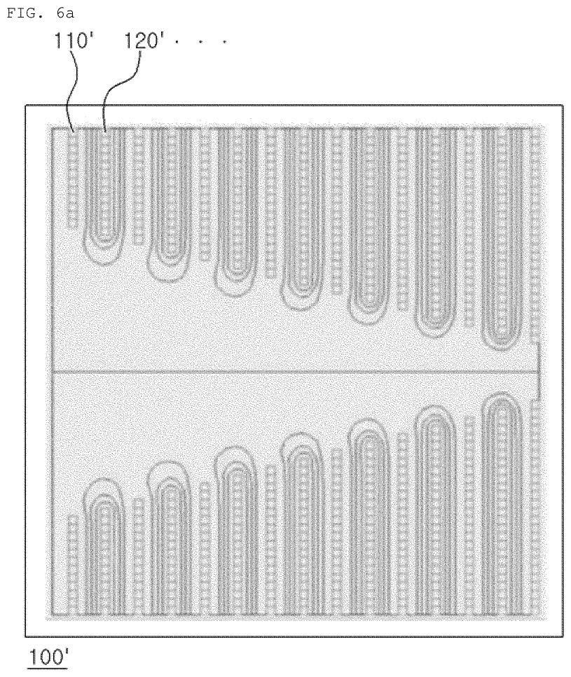

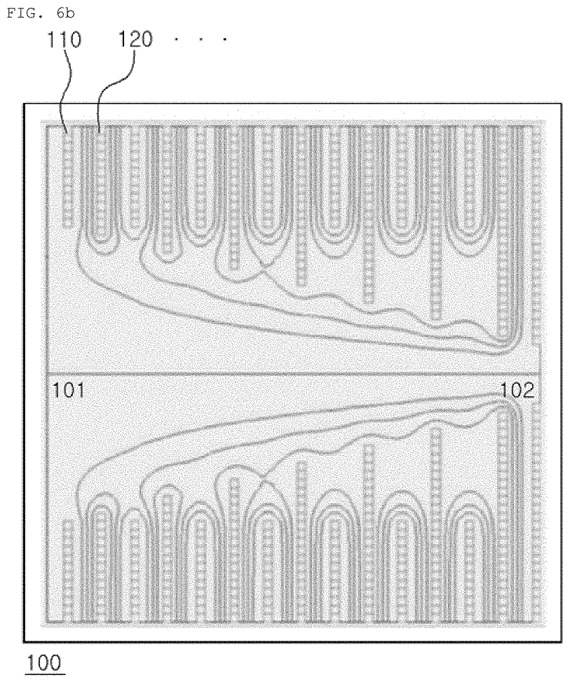

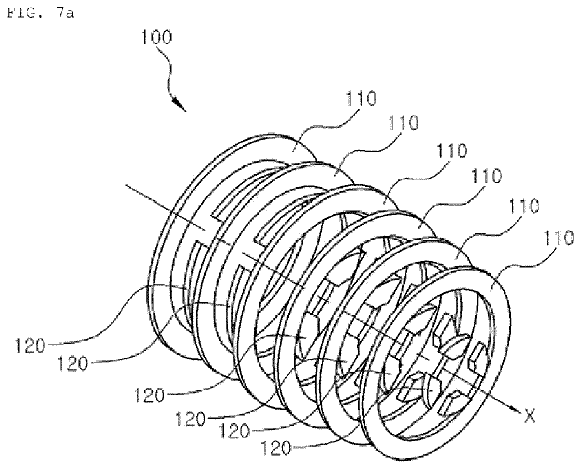

FIG. 6 is a diagram illustrating an electric field (6a) formed by the existing ion guide and an electric field (6b) formed by the ion guide according to the exemplary embodiment of the present invention.

As illustrated in FIG. 6, the existing ion guide 100′, that is, the ion guide having the form in which all the inner diameters of the DC ring 110′ and the RF multi-pole ring 120′ gradually decrease strongly forms an electric field only around the RF multi-pole ring (FIG. 6a), but according to the ion guide 100 of the present invention, the multi-pole electric field generated from the neighboring RF multi-pole ring 120 is maintained even inside the DC ring 110 and the electric field is strongly generated up to the central axis X of the ion guide far from the RF multi-pole ring 120, so ions may be more effectively collected on the central axis X of the ion guide 100 (FIG. 6b).

In addition, since the inlet 101 is formed to be larger than the outlet 102, it is easy to collect ions scattering in various directions in the inlet 101, and since the outlet 102 is formed to be narrow, it is efficient to transfer ions to a desired point.

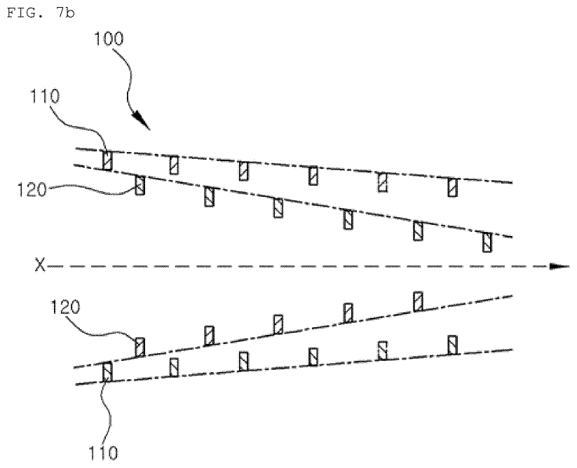

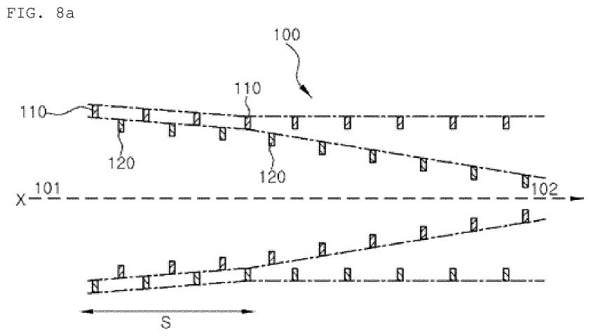

On the other hand, FIG. 7 is a perspective view (FIG. 7a) and a cross-sectional view (FIG. 7b) of an ion guide according to another exemplary embodiment of the present invention, and unlike the ion guide 100 according to the exemplary embodiment of the present invention described above, in the ion guide 100 according to another exemplary embodiment of the present invention, the inner diameter of the DC ring 110 is not kept constant in a direction from the inlet 101 to the outlet 102 but even the inner diameter of the DC ring 110 gradually decreases, but the degree to which the inner diameter of the RF multi-pole ring 120 decreases may be greater than the degree to which the inner diameter of the DC ring 100 decreases.

FIG. 8 is a cross-sectional view of an ion guide according to still another exemplary embodiment of the present disclosure. The ion guide 100 according to still another exemplary embodiment of the present invention is formed so that all the inner diameters of the DC ring 110 and the RF multi-pole ring 120 decrease at the same rate from the inlet 101 to a predetermined distance S. The ion guide 100 according to the exemplary embodiment of the present invention described above may be formed so that after the predetermined distance S to the outlet 102, the inner diameter of the DC ring 110 is kept constant and the inner diameter of the RF multi-pole ring 120 gradually decreases (FIG. 8a), whereas the ion guide 100 according to another exemplary embodiment of the present invention described above may be formed so that the inner diameters of the DC ring 110 and the RF multi-pole ring 120 gradually decrease, but the degree to which the inner diameter of the RF multi-pole ring 120 decreases may be greater than that of the decrease of the inner diameter 110 of the DC ring (FIG. 8b).

Here, the ion guide of the present invention is preferably arranged so that the inlet 101 of the ion guide starts with the DC ring 110 and the outlet 102 of the ion guide ends with the RF multi-pole ring 120.

In connection with the ion guide according to another exemplary embodiment of the present invention and the ion guide according to still another exemplary embodiment of the present invention, several specific modifications among the modifications of the ion guide that may be variously modified in the present invention are shown. In the ion guide according to another exemplary embodiment of the present invention and the ion guide according to still another exemplary embodiment described above, the multi-pole electric field made from the neighboring RF multi-pole ring 120 is maintained inside the DC ring 110 to some degree, and at the same time, a strong electric field is generated to the central axis X of the ion guide far away from the RF multi-pole ring 120, so ions may be more effectively collected on the central axis X of the ion guide 100.

In addition, since the inlet 101 is formed to be larger than the outlet 102, it is easy to collect ions scattering in various directions in the inlet 101, and since the outlet 102 is formed to be narrow, it is efficient to transfer ions to a desired point.

Meanwhile, the DC ring 110 and the RF multi-pole ring 120 shown in the present specification may have a circular ring shape, but may have various geometric shapes such as an ellipse or a polygon.

In addition, the thickness of the DC ring 110 and the RF multi-pole ring 120 shown in this specification is shown to be constant, but is not limited thereto, and the thickness of each DC ring 110 and RF multi-pole ring 120 may gradually become thinner or thicker.

In addition, although the RF multi-pole ring 120 shown in the present specification is illustrated to have four electrodes, a plurality of electrodes may be used, and a plurality of electrodes of 2, 4, 6, 8 or more are preferable.

In addition, the DC rings 110 and the RF multi-pole rings 120 constituting the ion guide 100 shown in the present specification are illustrated in a structure that is spaced apart from each other without any medium, but are sealed with an insulator or may be connected to each other via the insulator.

Hereinafter, the ion source 1 in which the ion guide 100 according to the present invention is embedded will be described.

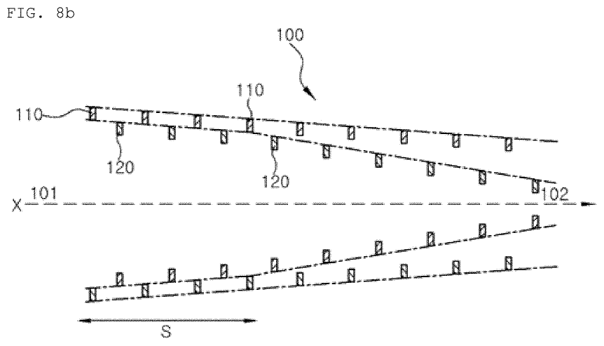

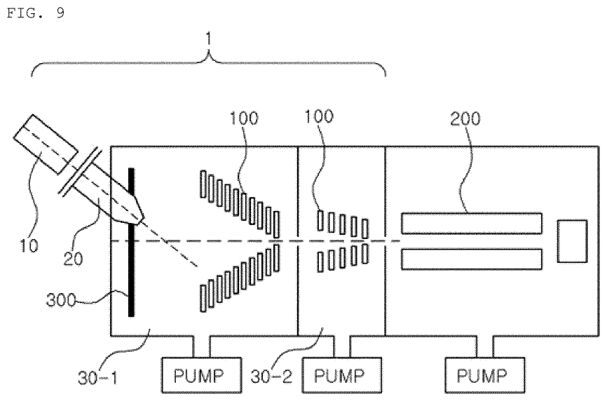

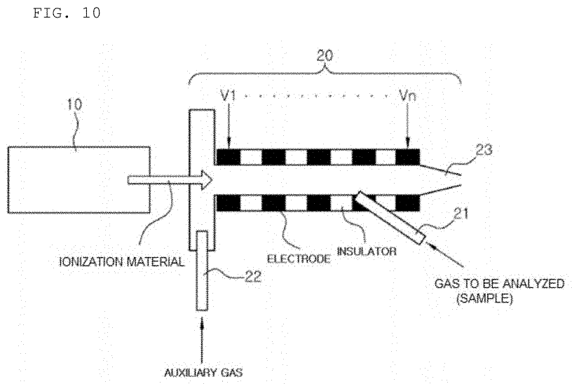

FIG. 9 is a diagram schematically illustrating a configuration of the ion source according to another exemplary embodiment of the present invention, and FIG. 10 is a diagram illustrating in detail an ionization chamber of the ion source.

The ion source 1 according to the present invention may be configured to include an ionization material source 10 for emitting an ionized material, an ionization chamber 20 for ionizing a sample, and at least one vacuum chamber 30.

As will be described later, the ionized material may be a photon when the ionization source 1 of the present invention is a photo-ionized ion source, may be a primary ion of a reagent in the case of a chemical ionization ion source, and may be a primary ion capable of transferring a proton in the case of a proton transfer reaction ion source, and in this case, the ionization material source 10 may be a known device or device that emits each kind of ionized material.

The ionization chamber 20 is constituted by DC electrodes and insulators therebetween, and the DC electrode is applied with a different voltage in the direction of the outlet 23 of the ionization chamber by the DC voltage dividing electric circuit (not illustrated) and thus the DC electric field may be generated in the ionization chamber 20 by a voltage difference.

The ion guide 100 of the present invention described above is embedded in the vacuum chamber 30, and the ion guide 100 in the vacuum chamber 30 operates under atmosphere of gas introduced from the ionization chamber outlet 23 into the vacuum chamber 30.

Hereinafter, in the present specification, the vacuum chamber 30 corresponding to the ion optical system immediately following the ionization chamber 20 will be described as a first vacuum chamber 30-1.

As illustrated in FIG. 10, the ion source 1 of the present invention has a sample inlet 21 and an auxiliary gas inlet 22 in the ionization chamber 20, and the sample to be analyzed through the sample inlet 21 is injected and moves into the ionization chamber 20, and is ionized by reacting with the ionized material emitted from the ionization material source 10 within the ionization chamber 20.

The auxiliary gas injected through the auxiliary gas inlet 22 of the ionization chamber 20 may be used for the purpose of controlling the ionization efficiency of the sample by adjusting the pressure of the ionization chamber.

According to the present invention, by injecting a sample to be analyzed from the ionization chamber outlet 23 to the opposite side of the outlet, the sample stays in the ionization chamber 20 for a long time to increase the ionization efficiency, and the ionized sample ions move to the outlet 23 of the ionization chamber using the DC electric field in the ionization chamber 20, thereby increasing the ion emission efficiency.

The sample ions that have passed through the outlet 23 of the ionization chamber and moved to the first vacuum chamber 30-1 are collected through the ion guide 100 in the first vacuum chamber 30-1, collected at the central axis X of the ion guide 100, and then transferred to the next ion optical system.

At this time, the ion optical system following the first vacuum chamber 30-1 may be the second vacuum chamber 30-2 when the ion source 1 is configured as a multi-stage vacuum system, and the ion source 1 may be the vacuum chamber with the mass analyzer 200 when the ion source 1 is configured as a single vacuum system.

Here, in the ion source 1 according to the present invention, the pressure inside the ionization chamber 20 may be formed to be lower than atmospheric pressure and higher than the pressure of the first vacuum chamber 30-1. As an example, the pressure in the ionization chamber 20 may be formed to be about 10 torr, and the pressure of the first vacuum chamber 30-1 may be formed to be about 1 torr. However, the present invention is not limited thereto, and the pressure in the ionization chamber 20 may be formed to be about 3 times or more than the pressure in the first vacuum chamber 30-1.

In this way, since the pressure in the ionization chamber 20 is formed to be higher than the vacuum pressure of the first vacuum chamber 30-1, the time that the gas stays in the ionization chamber 20 is longer than the time that the gas stays in the vacuum chamber 30-1 to increase the ionization efficiency of the sample, and the fragmentation of the acceleration of the sample ions less occurs due to less acceleration of the sample ions.

In addition, since the pressure in the ionization chamber 20 is lower than the atmospheric pressure, the amount of neutral gas molecules transferred from the ionization chamber 20 to the first vacuum chamber 30-1 is reduced compared to the case of ionizing the sample under the atmospheric pressure, and therefore, a small capacity pump may be applied to the first vacuum chamber 30-1.

Meanwhile, as illustrated in FIG. 9, in the ion source 1 according to the present invention, the central axis Y of the ionization chamber 20 and the central axis X of the ion guide 100 may be arranged to be inclined at a predetermined angle.

That is, the central axis Y of the ionization chamber 20 and the central axis X of the ion guide 100 are not disposed on the same line but is disposed to be inclined obliquely, so it is possible to minimize the transfer of the gas emitted from the outlet 23 of the ionization chamber to the next ion optical system.

At this time, the angle formed by the central axis Y of the ionization chamber 20 and the central axis X of the ion guide 100 may be 10 to 170°, and the central axis Y of the ionization chamber 20 and the central axis X of the ion guide 100 may be preferably formed to be perpendicular to each other, but are not limited thereto.

In this case, by arranging an ion deflector 300 on the opposite side of the side where the ion guide 100 is arranged in the first vacuum chamber 30-1, the outlet 23 of the ionization chamber may be disposed between the ion deflector 300 and the ion guide 100.

As the ion deflector 300 changes the direction of progression of the ions that are emitted from the ionization chamber 20 and scattered in various directions in the first vacuum chamber 30-1 to transmit the ions to the ion guide 100, the ion collection efficiency through the ion guide 100 increases and thus the ion detection sensitivity of the entire mass spectrometer increases.

Further, the ion source 1 according to the present invention may be constituted by a photoionization (PI) ion source, a chemical ionization (CI) ion source, or a proton transfer reaction (PTR) ion source.

In the present invention, since the pressure in the ionization chamber 20 may be higher than the vacuum as described above, in particular, when the ion source 1 is the PI ion source, the fragmentation phenomenon of the sample ions due to the collision of the sample ions generated in the photoionization process with neutral gas molecules or free electrons may be reduced.

Hereinabove, although the present invention has been described by specific matters, exemplary embodiments, and drawings, they have been provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to these exemplary embodiments, but the claims and all of modifications equal or equivalent to the claims are intended to fall within the scope and spirit of the present invention.

### DESCRIPTION OF REFERENCE SIGNS

100: Ion guide

101: Ion guide inlet

102: Ion guide outlet

110: DC ring

120: RF multi-pole ring

120a, 120b, 120c, 120d: Each segmented electrode of RF multi-pole ring

1: Ion source

10: Ionization material source

20: Ionization chamber

21: Sample inlet

22: Auxiliary gas inlet

23: Ionization chamber outlet

30: Vacuum chamber

200: Mass analyzer

300: Ion deflector

1. An ion guide for transferring ions,
wherein a plurality of DC rings and a plurality of RF multi-pole rings with a plurality of electrodes is arranged so as to intersect with each other between an inlet into which the ions move and an outlet for transferring the ions, and
an inner diameter of the DC rings is kept constant and an inner diameter of the RF multi-pole rings gradually decreases in a direction from the inlet to the outlet.

2. The ion guide of claim 1, wherein each center of the plurality of DC rings and the plurality of RF multi-pole rings is located on a straight line.

3. The ion guide of claim 1, wherein the inner diameter of the RF multi-pole ring decreases at a constant rate.

4. The ion guide of claim 1, wherein the plurality of electrodes of a respective RF multi-pole ring are arranged to be spaced apart from each other to form a ring shape.

5. The ion guide of claim 1, wherein the plurality of RF multi-pole rings have a same distance from the inner diameter to an outer diameter.

6. The ion guide of claim 1, wherein an RF voltage having a same amplitude but different phases is applied to each neighboring electrode of the respective RF multi-pole ring.

7. The ion guide of claim 1, wherein a DC bias voltage applied to a DC ring is different from a DC bias voltage applied to a neighboring RF multi-pole ring.

8. An ion guide for transferring ions in which a plurality of DC rings and a plurality of RF multi-pole rings with a plurality of electrodes are arranged so as to intersect with each other between an inlet into which the ions move and an outlet for transferring the ions,
wherein all inner diameters of the DC rings and the RF multi-pole rings gradually decrease in a direction from the inlet end to the outlet end, and
a degree of decreasing the inner diameter of the RF multi-pole rings is greater than that of the DC rings.

9. An ion guide for transferring ions, wherein
in which a plurality of DC rings and a plurality of RF multi-pole rings with a plurality of electrodes are arranged so as to intersect with each other between an inlet into which the ions move and an outlet for transferring the ions,
wherein all inner diameters of the DC rings and the RF multi-pole rings decrease at a same rate from the inlet to a predetermined distance point, and
wherein, from the predetermined distance point to the outlet,
(i) the inner diameter of the DC rings is kept constant and the inner diameter of the RF multi-pole rings gradually decreases toward the outlet, or
(ii) both of the inner diameters of the DC rings and the RF multi-pole rings gradually decrease toward the outlet, wherein a degree of decreasing the inner diameter of the RF multi-pole rings is greater than that of the DC rings.

10. An ion source, comprising:
an ionization material source for emitting an ionization material; an ionization chamber in which a sample is ionized by the ionization material emitted from the ionization material source; and
at least one vacuum chamber for transferring ions of the sample ionized by the ionization chamber to a next ion optical system,
wherein the ion guide of claim 1 is contained in a vacuum chamber.

11. The ion source of claim 10, wherein the ionization chamber comprises
DC electrodes with different voltages applied toward an outlet of the ionization chamber, and
insulators each disposed between respective DC electrodes.

12. The ion source of claim 10, wherein a pressure inside the ionization chamber is higher than a pressure inside a first vacuum chamber in which the ion optical system immediately following the ionization chamber is contained and lower than an atmospheric pressure.

13. The ion source of claim 12, wherein a central axis of the ionization chamber and the central axis of the ion guide of the first vacuum chamber are arranged to be inclined at a predetermined angle, arranged to be spaced apart from each other, or arranged to be spaced apart from each other ad inclined.

14. The ion source of claim 13, wherein the angle formed by the central axis of the ionization chamber and the central axis of the ion guide of the first vacuum chamber is 10° to 170°.

15. The ion source of claim 12, wherein an ion deflector is placed inside the first vacuum chamber on an inlet side of the ion guide, and
an outlet of the ionization chamber is placed between the ion deflector and the ion guide.

16. The ion source of claim 10, wherein the ion source is a photoionization ion source, a chemical ionization ion source, or a proton transfer reaction ion source.
